(19) United States
(12) Patent Application Publication
(10) Pub. No.: US 2011/0316616 A1
(43) Pub. Date: Dec. 29, 2011

(54) SEMICONDUCTOR INTEGRATED CIRCUIT FOR CONTROLLING POWER SUPPLY

(75) Inventor: Hitoshi YODA, Yokohama (JP)

(73) Assignee: FUJITSU SEMICONDUCTOR LIMITED, Yokohama-shi (JP)

(21) Appl. No.: 13/052,850

(22) Filed: Mar. 21, 2011

(30) Foreign Application Priority Data
Jun. 28, 2010 (JP) 2010-146502

(51) Int. Cl. G05F 1/10

(52) U.S. Cl. 327/535

(57) ABSTRACT

A semiconductor integrated circuit includes a plurality of circuit regions, at least one power source switch that switches between two states of supplying power or not supplying power to at least one of the plurality of circuit regions, a power source control circuit that controls the at least one power source switch, a clamp scan chain having a plurality of flip-flops to which an output from the at least one circuit region to another region is input, and a clamp data control circuit that sets the plurality of flip-flops of the clamp scan chain to a predetermined output state.

### CROSS-REFERENCE TO RELATED APPLICATIONS

This application is based upon and claims the benefit of priority of the prior Japanese Patent Application No. 2010-146502, filed on Jun. 28, 2010, the entire contents of which are incorporated herein by reference.

### FIELD

The embodiments discussed herein are related to a semiconductor integrated circuit having a plurality of circuit regions and controlling the supply of power source to at least part of the circuit regions.

### BACKGROUND

As miniaturization of semiconductor devices due to improvements in process technique advances, the leak current which cannot be ignored occurs and the power gating (PG) technique for cutting off the supply of power to each region is being applied in order to reduce the leak of power in circuit regions not used inside an LSI. A region in which the supply of power is turned on/off is referred to as a domain.

When the PG technique is applied, a signal output from a domain to which the power source is cut off results in high impedance (Hi-Z), and therefore, it is necessary to clamp the signal with an isolator (ISO) cell. At present, the ISO cell is inserted with a tool or manually.

Further, it is difficult to perform the operation test of an LSI as the degree of integration increases and the functions of the semiconductor devices are increased. Because of this, a scan chain is formed inside an LSI, the state inside the LSI is set to a desired state by the scan chain and then operated, and the state after the operation is read by the scan chain.

However, the insertion of the ISO cell causes the number of logic stages to increase, and therefore, there is a problem that the frequency (performance) is reduced. Further, the ISO cell is inserted into all the signals output from the domain the power source of which is cut off, and therefore, the circuit scale (number of gates) of the ISO cell increases. When the number of gates increases, if the ISO cell is inserted with a tool or manually, the frequency of errors becomes higher. If the ISO cell is inserted (clamped to High or Low) with an erroneous data value and assembled into the LSI, a malfunction occurs when the power source is cut off as a result.

Realization of a semiconductor integrated circuit in which the circuit scale of the isolator (ISO) cell is small, the operation speed in the ISO cell is high, and an erroneous setting of the ISO cell can be has been demanded.

### RELATED DOCUMENTS

[Patent Document 1] Japanese Laid-open Patent Publication No. 2003-098223
[Patent Document 2] Japanese Laid-open Patent Publication No. 2008-078754

### SUMMARY

According to an aspect of embodiments, a semiconductor integrated circuit includes a plurality of circuit regions, at least one power source switch that switches between whether or not to supply power to at least one of the plurality of circuit regions, a power source control circuit that controls the at least one power source switch, a clamp scan chain having a plurality of flip-flops to which an output from the at least one circuit region to another region is input, and a clamp data control circuit that sets the plurality of flip-flops of the clamp scan chain to a predetermined output state.

The object and advantages of the embodiments will be realized and attained by means of the elements and combination particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a general configuration diagram of a semiconductor device in which the control of power source of two domains inside a semiconductor integrated circuit (LSI) is performed using a power management unit (PMU);

FIG. 2 is a diagram illustrating an example in which a signal output from a logic circuit in a B domain to a logic circuit in an A domain is clamped by an ISO cell because the signal becomes Hi-Z when the power source of the B domain is turned off;

FIG. 3 is a diagram illustrating an example of an LSI into which a scan chain is inserted;

FIG. 4 is an operation flowchart when a power source switch transistor is turned off and the supply of power source of the B domain is terminated in the LSI in FIG. 3;

FIG. 5 is a time chart of the operation in FIG. 4;

FIG. 6 is a diagram illustrating a configuration of a semiconductor integrated circuit (LSI) in a first embodiment;

FIG. 7 is a truth table of the operation of an SFF that forms a clamp scan chain;

FIG. 8 is a diagram illustrating a general configuration of a clamp control circuit;

FIG. 9 is a flowchart illustrating an operation to turn off the power source of a main part 12C of the B domain;

FIG. 10A is a time chart of the entire LSI at the time of an operation to turn off the power source of the main part of the B domain;

FIG. 10B is a time chart of the SFF at the time of an operation to turn off the power source of the main part of the B domain;

FIGS. 11A to 11C are time charts of an operation to change a data value;

FIG. 12 is a diagram illustrating a configuration of a semiconductor integrated circuit (LSI) in a second embodiment.

### DESCRIPTION OF EMBODIMENTS

Before describing the embodiments, an example of a semiconductor device having a plurality of circuit regions (domains) and controlling the supply of power to at least part of the circuit regions will be explained.

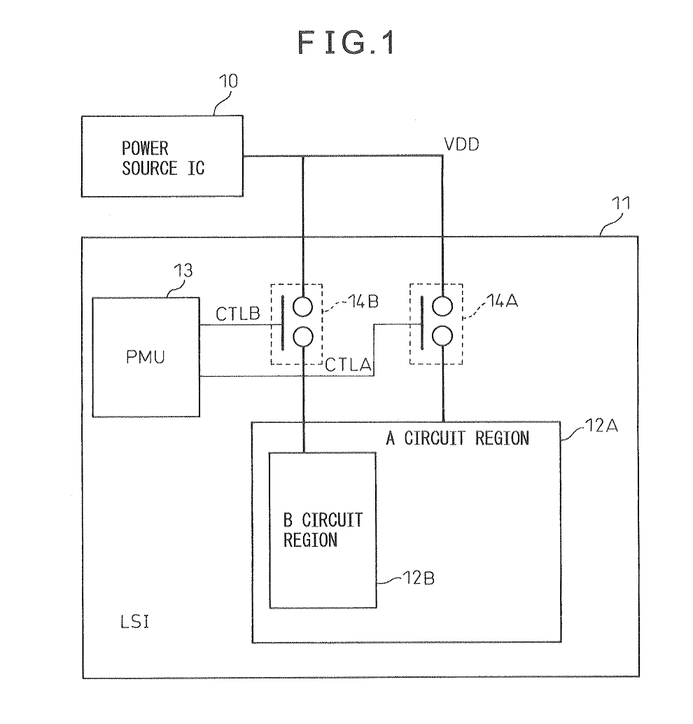

FIG. 1 is a general configuration diagram of the above semiconductor device in which the control of power source of two domains inside a semiconductor integrated circuit (LSI) is performed using a power management unit (PMU). As illustrated in FIG. 1, to an LSI 11, a power source VDD is supplied from a power source IC 10. Although not illustrated schematically, the LSI 11 is also connected the ground GND.

The LSI 11 has an A circuit region (domain) 12A, a B circuit region (domain) 12B included in the domain 12A, a power management unit (PMU) 13, and two power source switches 14A and 14B. The number of domains is not limited to two and there is a case where three or more domains are provided. The PMU 13 is arranged in a domain the power source of which is always ON. The A domain 12A and the B domain 12B are domains the power source ON/OFF of which is controlled by the PG technique. The power source switches 14A and 14B are arranged between the power source VDD supply line from the power source IC 10 and the power source line of the A domain 12A and the B domain 12B, respectively, and controlled by control signals CTLA and CTLB from the PMU 13. In the example in FIG. 1, the B domain 12B is included in the A domain 12A as illustrated in FIG. 1, however, there is a case where the A domain 12A and B domain 12B are provided separately. In the following explanation, an example is illustrated, in which the B domain 12B is included in the A domain 12A, however, this is not limited.

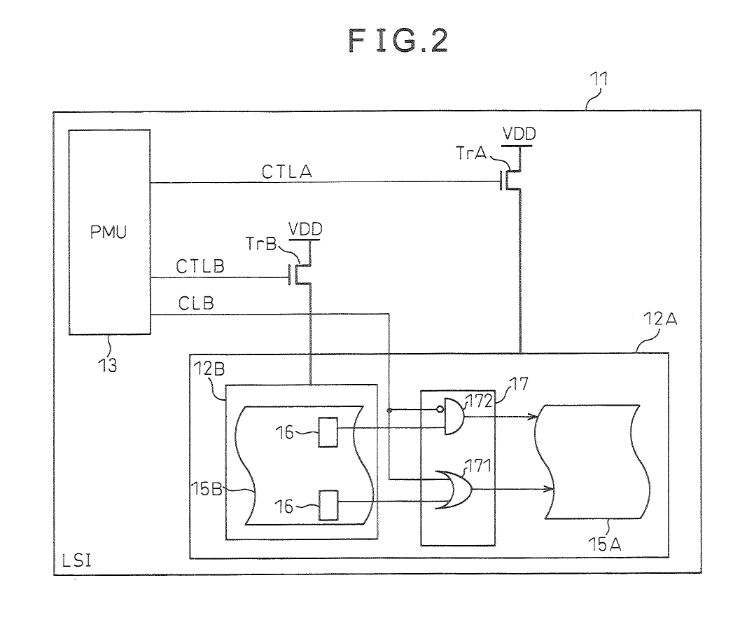

FIG. 2 is an explanatory diagram concerning a relationship of signals between the B domain 12B, which is focused on here, and the A domain 12A in FIG. 1 and also concerning the control signals CTLA and CTLB from the PMU 13. In FIG. 2, a case is illustrated, where the power source switches 14A and 14B are formed by NMOS transistors TrA and TrB, however, it is also possible to form by PNOS transistors. Further, it is also possible to provide a power source switch to the power source line on the ground side. The supply of power source of the PMU 13 is not illustrated schematically.

FIG. 2 illustrates an example, in which a signal output from a logic circuit 15B in the B domain 12B to a logic circuit 15A in the A domain 12A is clamped by an ISO cell 17 because the impedance of the signal becomes Hi-Z when the power source of the B domain is turned off. It is common to use an ISO cell 172 of AND type when the output from an output circuit 16 in the B domain 12B is clamped to “L (Low)” and an ISO cell 171 of OR type when clamped to “H (High)”.

It is difficult to perform the operation test of an LSI as the degree of integration increases and the functions of the semiconductor devices increase. Because of this, a scan chain is formed inside an LSI, the state inside the LSI is set to a desired state by the scan chain and then operated, and the state after the operation is read by the scan chain.

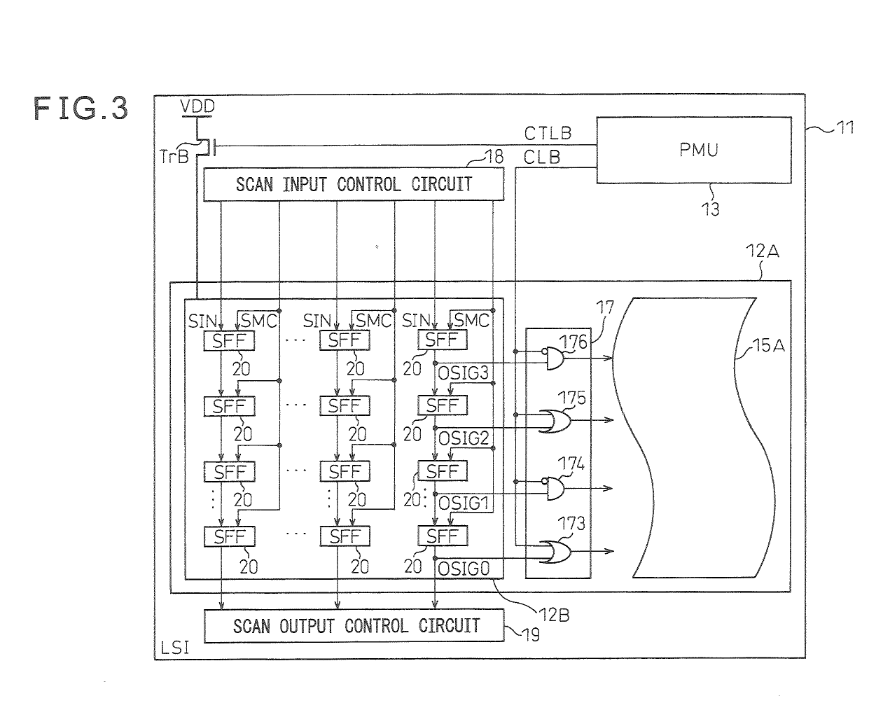

FIG. 3 is a diagram illustrating an example of an LSI into which a scan chain is inserted. In FIG. 3, an SFF 20 is a scan flip-flop (SFF) that forms a scan chain in the B domain 12B. FIG. 3 illustrates an example in which a plurality of scan chains is formed. A scan input control circuit 18 outputs scan data to be input to the SFF 20 of the scan chain in the scan mode and a control signal SMC that controls taking in of the scan data to the SFF 20. A scan output control circuit 19 receives the scan data output from the SFF 20 in the scan mode and outputs it to outside.

The SFF 20 takes in the scan data input from a signal input terminal SIN while SMC is at High and holds and outputs the scan data taken in while SMC is at Low. Consequently, the SFF 20 that forms the scan chain forms a shift register as a result and the scan data from the scan input control circuit 18 is set to the SFF 20 sequentially. Because of this, it is possible to set the B domain 12B in a desired state. Although not illustrated schematically, the SFF 20 has a switch arranged corresponding to the signal input terminal SIN, and therefore, it is possible to take in a signal for the circuit operation in the normal mode. When SMC is held at Low and the B domain 12B is operated in the normal mode after setting the SFF 20 of the scan chain to a desired state in the scan mode, the state of the B domain 12B changes. After causing the B domain 12B to operate normally for a period of time corresponding to a desired number of clocks, the mode is set to the scan mode and the data of the SFF 20, i.e., the data about the operating state of the B domain 12B is input to the scan output control circuit 19 sequentially. Due to this, it is possible to obtain data on the operating state of the B domain 12B and to conduct a desired operation test.

In FIG. 3, the isolator (ISO) cell 17 has AND type ISO cells 174 and 176 and OR type ISO cells 173 and 175. The ISO cells 173 to 176 clamp outputs OSIG 0 to OSIG 3 from the B domain 12B to the A domain 12A when the supply of power source to the B domain 12B is terminated. The OSIG 0 to OSIG 3 are outputs of the SFF 20 that forms one of the scan chains.

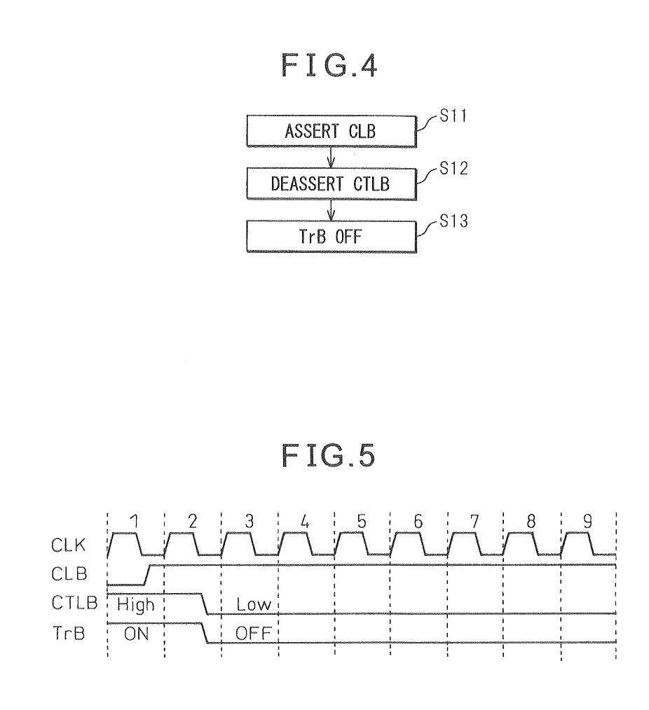

FIG. 4 is an operation flowchart when TrB is turned off and the supply of power source of the B domain 12B is terminated in LSI in FIG. 3 and FIG. 5 is a time chart in such a case.

Before the supply of power source is terminated, the PMU 13 outputs Low as a signal CLB to be input to the ISO cells 173 to 176. Due to this, the ISO cells 173 to 176 let the outputs OSIG 0 to OSIG 3 of the B domain 12B to the A domain 12A pass.

In step S11, the PMU 13 asserts the signal CLB to be input to the ISO cells 173 to 176 and switches it to High. Due to this, the outputs of the ISO cells 173 to 176 are clamped to High, Low, High, and Low. In other words, the outputs OSIG 0 to OSIG 3 from the B domain 12B to the A domain 12A are clamped.

In step S12, the PMU 13 deasserts CTLB and switches it to Low. Due to this, TrB turns off and the power source of the B domain 12B is cut off.

To resume the supply of power source of the B domain 12B, perform the reverse operation of the above.

In the LSI 11 illustrated in FIG. 3, the ISO cells 173 to 176 are inserted to clamp the signal output from the B domain 12B the power source of which is turned off, however, at present, the insertion is performed with a tool or manually. However, as described above, the insertion of the ISO cell causes the number of logic stages to increase, and therefore, there is such a problem that the frequency (performance) is reduced. Further, the ISO cell is inserted into all the signals output from the domain the power source of which is cut off, and therefore, the circuit scale (number of gates) of the ISO cell 17 increases. When the number of gates increases, if the ISO cell is inserted with a tool or manually, the possibility of the occurrence of an error becomes stronger. If the ISO cell is inserted (clamped to High or Low) with an erroneous data value and assembled into the LSI, a malfunction occurs when the power source is cut off as a result.

According to embodiments, a semiconductor integrated circuit (LSI) is realized, in which the circuit scale of the isolator (ISO) cell is reduced, the operation speed in the ISO cell is increased, and even an erroneous setting may be easily modified.

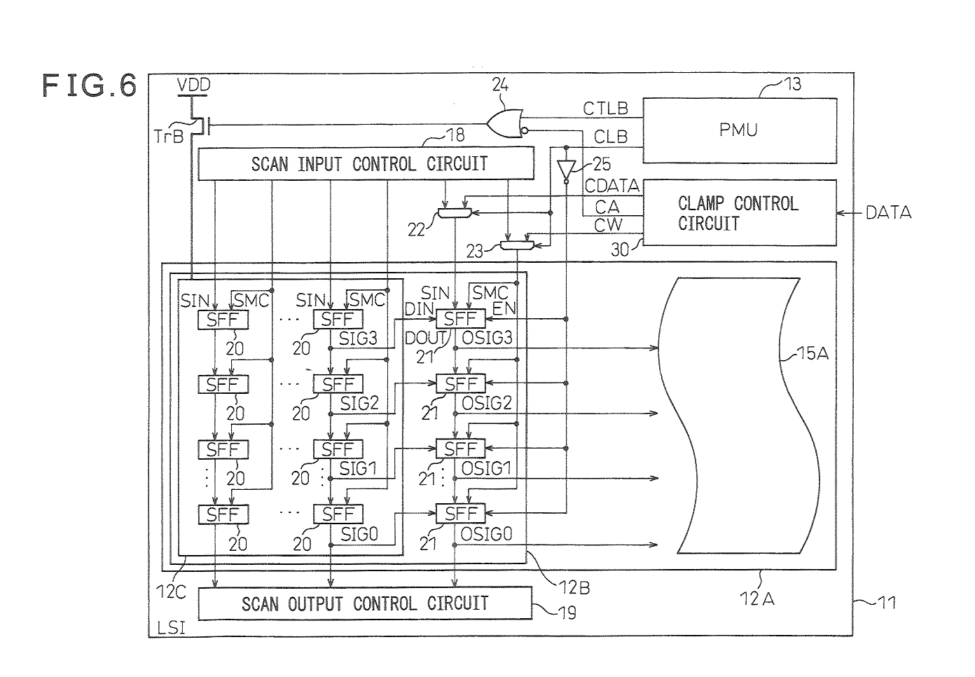

FIG. 6 is a diagram illustrating a configuration of a semiconductor integrated circuit (LSI) 11 in a first embodiment.

As illustrated in FIG. 6, the LSI 11 in the first embodiment has an A circuit region (domain) 12A, a B circuit region (domain) included in the domain 12A, a power management unit (PMU) 13, a transistor TrB that operates as a power source switch, a scan input control circuit 18, a scan output control circuit 19, selectors 22 and 23, an OR gate 24, an inverter 25, and a clamp control circuit 30.

The PMU 13 is arranged in a domain the power source of which ON at all times. The A domain 12A may be or may not be a domain the power source ON/OFF of which is controlled by the PG technique.

The B domain 12B is a part designed in the same logic layer. The B domain 12B is divided into a main part 12C and other output parts and the main part 12C is a domain the power source ON/OFF of which is controlled by the PG technique. When the A domain 12A is an object the power source ON/OFF of which is controlled, the supply of power source of the output part of the B domain 12B is controlled in the same manner as that of the A domain 12A. As described previously, the B domain 12B may be provided independently of the A domain 12A.

TrB is arranged between a power source VDD supplied from outside and a power source line of the main part 12C of the B domain 12B and controlled by an output of the OR gate 24. The OR gate 24 outputs the logical OR of a control signal CTLB output from the PMU 13 and an inverted signal of a control signal CA output from the clamp control circuit 30. The PMU 13 outputs a signal CLB that controls the setting of clamp data CDATA. Although not illustrated schematically, the power source VDD is supplied to parts of the LSI 11 other than the main part 12C. The LSI 11 is connected also to a ground GND. Further, as described previously, it is also possible to provide a power source switch between the main part 12C of the B domain 12B and the ground GND to control the supply of power source to the B domain 12B.

The main part 12C of the B domain 12B includes a plurality of scan chains. Each scan chain has a plurality of scan flip-flops (SFF) 20 connected in series and forms a shift register. The SFF 20 takes in scan data input from a signal input terminal SIN while SMC is at High and holds and outputs the scan data that is taken in while SMC is at Low. Although not illustrated schematically, the SFF 20 has a switch arranged corresponding to the signal input terminal SIN and is capable of taking in a signal for the circuit operation in the normal mode.

The scan input control circuit 18 outputs scan data to be input to the SFF 20 of the scan chain in the scan mode and the control signal SMC that controls the taking in of the scan data to the SFF 20. The scan output control circuit 19 receives the scan data output from the SFF 20 in scan mode and outputs it to outside.

Output parts of the B domain 12B other than the main part 12C have a clamp scan chain. The clamp scan chain has a plurality of scan flip-flops (SFF) 21 connected in series and forms a shift register. The SFF 21 has the signal input terminal SIN that receives scan data and a signal input terminal DIN that receives an output of the circuit of the main part 12C (here, an output of SFF). Further, the SFF 21 receives the control signal SMC, an enable signal EN, and a clock signal CLK, not illustrated schematically, and generates an output DOUT corresponding to the input.

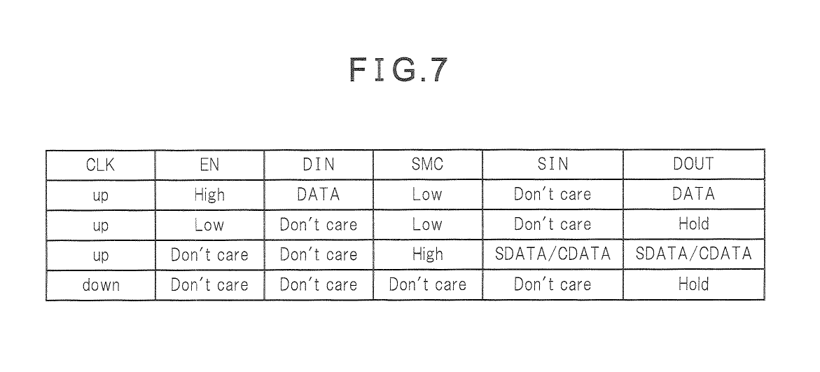

FIG. 7 is a truth table of the operation of the SFF 21 that forms a clamp scan chain. The SSF 21 takes in data DATA from DIN in synchronization with the rise of CLK when EN is at High and SMC is at Low and outputs DATA from DOUT. Consequently, in this state, the output of the circuit of the main part 12C enters a logic circuit 15A of the A domain 12A as it is in synchronization with CLK.

The SFF 21 maintains the state even if CLK rises when EN is at Low and SMC is at Low and the output does not change.

The SFF 21 takes in scan data SDATA (or CDATA) from SIN in synchronization with the rise of CLK when SMC is at High and outputs SDATA (or CDATA) from DOUT. At this time, EN may be at High or Low. Further, at the fall of CLK, the SFF 21 does not change.

The operation of the SFF 21 is not problematic even if a signal input to DIN becomes Hi-Z.

The output DOUT of the SFF 21 of the clamp scan chain is input to the logic circuit 15A in the A domain 12A.

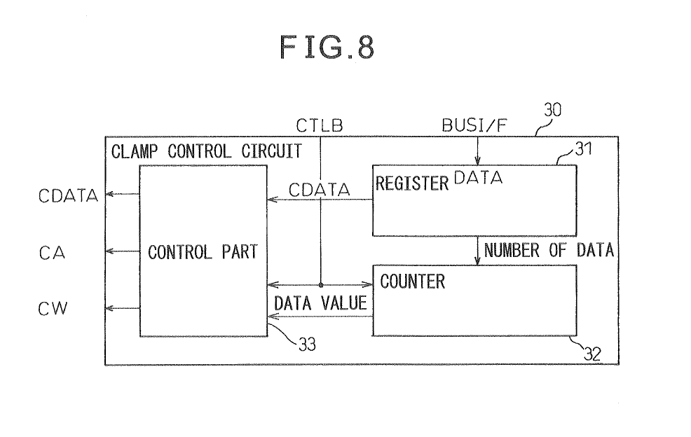

FIG. 8 is a diagram illustrating a general configuration of the clamp control circuit 30.

As illustrated in FIG. 8, the clamp control circuit 30 has a register 31, a counter 32, and a control part 33. The register 31 stores the clamp data CDATA input via an external bus interface BUS/IF and the number of pieces of the data. The register 31 outputs the number of pieces of the CDATA data to the counter 32 as well as outputting CDATA in accordance with access from the control part 33 when cutting off the power source of the main part 12C of the B domain 12B. The counter 32 is a down counter and starts the counting operation when CTLB of the PUM 13 is deasserted and becomes Low and outputs the count value to the control part 33. The control part 33 outputs CDATA as well as generating and outputting the clamp acknowledge signal CA and a clamp write signal CW based on the count value.

As described previously, the clamp acknowledge signal CA is inverted and input to the OR gate 24.

The selector 22 selects one of the scan data SDATA output from the scan input control circuit 18 and the clamp data CDATA output from the clamp control circuit 30 in accordance with CLB output from the PMU 13. The output selected by the selector 22 is input to the SIN terminal of the SFF 21 in the first stage of the clamp scan chain. The selector 23 selects one of SMC output from the scan input control circuit 18 and CW output from the clamp control circuit 30 in accordance with CLB. The output selected by the selector 23 is input to the SMC terminal of all the SFFs 21 of the clamp scan chain. CLB output from the PMU 13 is inverted by the inverter 25 and input to the EN terminal of all the SFFs 21 of the clamp scan chain.

Next, the operation to turn off the power source of the main part 12C of the B domain 12B in the LSI 11 in the first embodiment is explained.

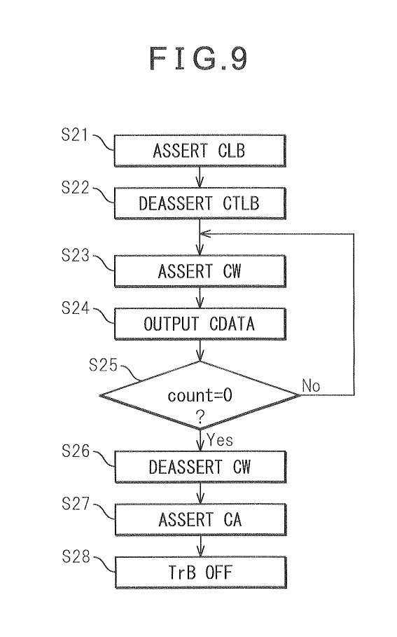

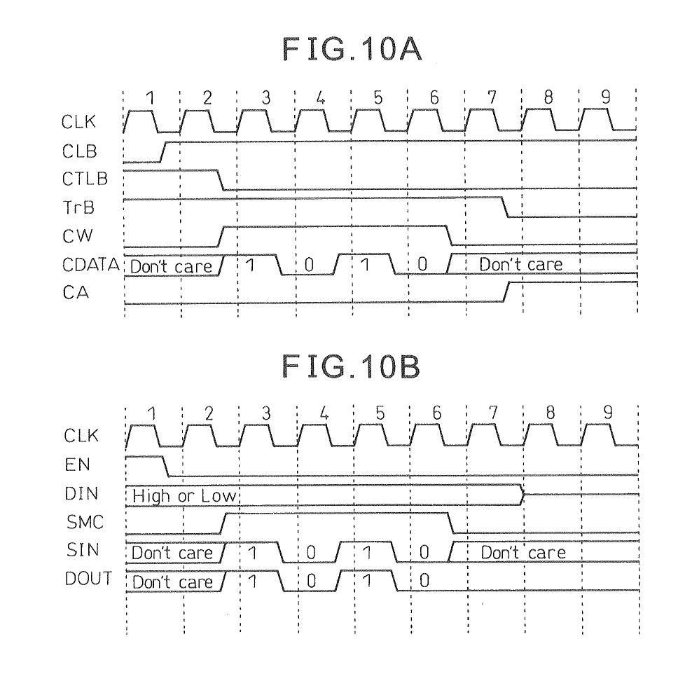

FIG. 9 is a flowchart illustrating the operation to turn off the power source of the main part 12C. FIG. 10 is a time chart at the time of the operation to turn off the power source of the main part 12C, wherein FIG. 10(A) is a time chart of the whole LSI 11 and FIG. 10B is a time chart of SFF.

In step S21, the MUP 13 asserts CLB and turns it to High. Due to this, CDATA and CW are selected by the selectors 22 and 23 and input to SIN and SMC of the SFF 22 and at the same time, EN of the SFF 22 is asserted and turned to Low.

In step S22, the PMU 13 deasserts CTLB and turns it to Low, however, CA is Low and therefore the output of the OR gate 24 remains High and the power source of the B domain 12B is not cut off yet.

In step S23, the clamp control circuit 30 asserts CW and turns it to High.

In step S24, at the same time as step S23, the clamp control circuit 30 sets data (at High/Low) desired to be clamped by the final SFF 21 to CDATA. In the example of the time chart in FIG. 10A, the values are set in order of High (1), Low (0), High (1), and Low (0). Therefore, CA is High at the beginning.

In step S25, whether the data setting of all the SFFs 21 of the clamp scan chain is completed is determined and if not completed yet, the processing returns to step S23 and step 23 to step 25 are repeated and when completed, the processing proceeds to step S26. This operation is performed by causing the counter 32 to count down by the number corresponding to the number of the SFFs 21. Due to this, DOUT of the SFF 21 turns to High, Low, High, and Low in this order.

In step S26, when the data setting of all the SFFs 21 is completed, the clamp control circuit 30 deasserts CW and turns it to Low.

In step S27, the clamp control circuit 30 asserts CA and turns it to High.

In step S28, at the same time as step 27, TrB turns off and the power source of the main part 12C of the B domain 12B is cut off. At this time, Hi-Z is input to DIN of the SFF 21, however, EN of the SFF 22 is deasserted and at Low, and therefore, DIN is invalidated. As described previously, parts of the B domain 12B other than the main part 12C in which the clamp scan chain is formed are not connected to the power source via TrB, and therefore, the power source of the clamp scan chain is not turned off and remains in the operating state.

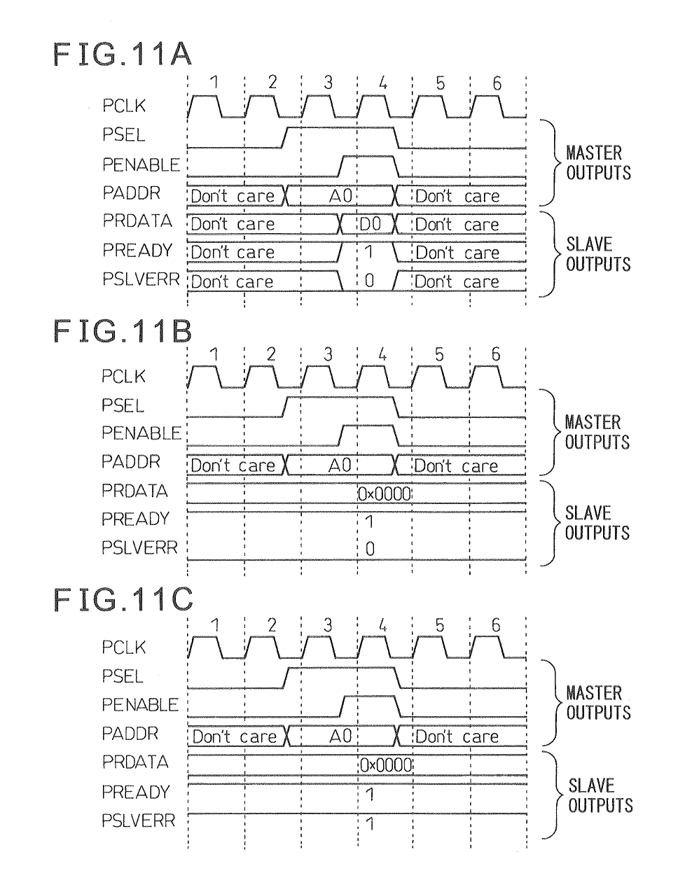

It is possible to realize the clamp scan chain using an already existing scan chain. By using an already existing scan chain, the output from the domain the power source of which is to be turned off may be set to a data value to be clamped, and therefore, it is possible to change the data value (High/Low) after manufacturing the LSI 11 in the first embodiment. A specific example when the data value is changed is explained with reference to the time chart in FIG. 11.

FIG. 11A is a time chart of read access using the AMBA (registered trademark) APB protocol. Here, the master is the logic circuit 15 in the A domain 12A and the slave is the B domain 12B.

The slave asserts PREADY and turns it to High in the fourth cycle of PCLK and at this time, PSLVERR is deasserted and turned to Low, and therefore, it indicates that the transfer is performed normally.

FIG. 11B is a time chart when PSLVERR is clamped to the Low side when the power source of the slave is turned off in the operation in FIG. 10A. PREADY is asserted and turned to High and PSLVERR is deasserted and clamped to Low to prevent a hangup even if a slave the power source of which is turned off is accessed.

FIG. 11C is a time chart when PSLVERR is clamped to the High side when the power source of the slave is turned off in the operation in FIG. 10A. PSLVERR is asserted and clamped to High to indicate the data is not valid when a slave the power source of which is turned off is accessed.

As described above, it is possible for the LSI 11 in the first embodiment to change the data value to clamp the output from the domain the power source of which. is to be turned off in accordance with uses or circumstances.

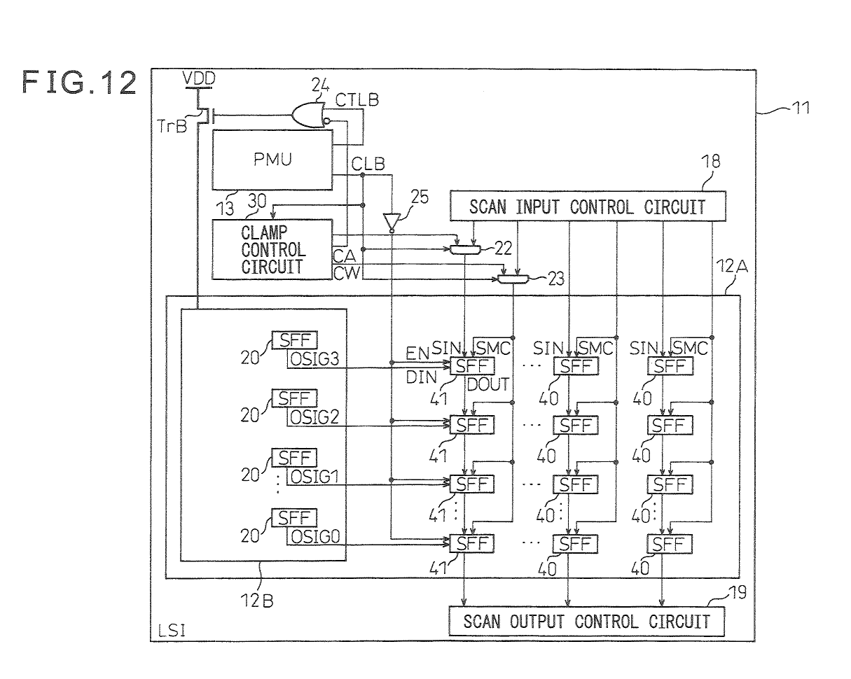

FIG. 12 is a diagram illustrating a configuration of a semiconductor integrated circuit (LSI 11) in a second embodiment. The second embodiment differs from the first embodiment in that the scan chain is formed also in the logic circuit of the A domain 12A and the clamp scan chain that clamps the output from the B domain 12B when the power source of the B domain 12B is cut off is formed in the A domain 12A. The A domain 12A includes a plurality of scan chains and each scan chain has a plurality of SFFs 40 connected in series and forms a shift register. The scan chain of the A domain 12A is connected to the scan input control circuit 18 and the scan output control circuit 19.

Further, the clamp scan chain has a plurality of SFFs 41 connected in series and forms a shift register. To the DIN terminal of the SFF 41, the outputs OSIGO to OSIG3 of the B domain 12B are input.

The operation of the clamp scan chain in the second embodiment is the same as that in the first embodiment, and therefore, its explanation is omitted.

In the second embodiment, the clamp scan chain is realized by using the scan chain on the input side of the A domain 12A. Consequently, it is possible to cut off the entire power source of the B domain without the need to include part of the B domain 12B in which the clamp scan chain is formed in the A domain 12A.

As explained above, in the first and second embodiments, by deasserting EN of SFF of the output or input and turning it to Low, DIN is invalidated, and therefore, the insertion of the ISO cell is no longer necessary. Further, it is made possible to set a value to be clamped using a scan chain.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention. have been described in detail, it should be understood that the various changes, substitutions, and alterations could be made hereto without departing from the spirit and scope of the invention.

What is claimed is:

1. A semiconductor integrated circuit comprising:
a plurality of circuit regions;
at least one power source switch that switches between two states of supplying power or not supplying power to at least one of the plurality of circuit regions;
a power source control circuit that controls the at least one power source switch;
a clamp scan chain having a plurality of flip-flops to which an output from the at least one circuit region to another region is input; and
a clamp data control circuit that sets the plurality of flip-flops of the clamp scan chain to a predetermined output state.

2. The semiconductor integrated circuit according to claim 1, wherein
the at least one circuit region and the plurality of flip-flops of the clamp scan chain are supplied with power sources of different systems, however, located in the same logic layer.

3. The semiconductor integrated circuit according to claim 1, wherein
the at least one circuit region and the plurality of flip-flops of the clamp scan chain are located in different logic layers.

4. The semiconductor integrated circuit according to claim 1, wherein
the clamp data control circuit comprises a set data storage part that stores data about the predetermined output state of the plurality of flip-flops of the clamp scan chain.

5. The semiconductor integrated circuit according to claim 4, wherein
the set data storage part stores data about the predetermined output state of the plurality of flip-flops of the clamp scan chain supplied via an external terminal.

6. The semiconductor integrated circuit according to claim 1, wherein
the clamp data control circuit comprises a counter that counts the number of the plurality of flip-flops of the clamp scan chain.

7. The semiconductor integrated circuit according to claim 1, wherein
the at least one circuit region. comprises a scan chain to conduct a test, and
the scan chain includes the clamp scan chain.

8. The semiconductor integrated circuit according to claim 7, wherein
the at least one circuit region comprises:
a scan input control circuit that controls a data input to the scan chain and its operation; and
a scan output control circuit that receives a data output from the scan chain.

9. The semiconductor integrated circuit according to claim 8, comprising a data selector that selects one of the data about the predetermined output state of the plurality of flip-flops of the clamp scan chain from the clamp data control circuit and the data input from the scan input control circuit and inputs it to the plurality of flip-flops of the clamp scan chain.

10. The semiconductor integrated circuit according to claim 8, comprising a control signal selector that selects one of a setting control signal to set the predetermined output state of the plurality of flip-flops of the clamp scan chain from the clamp data control circuit and an operation control signal from the scan input control circuit and inputs it to the plurality of flip-flops of the clamp scan chain.
